(19) United States
(12) Patent Application Publication
(10) Pub. No.: US 2007/0296113 A1
(43) Pub. Date: Dec. 27, 2007

(54) Production method of polymer film

(75) Inventors: Nobuo Hamamoto, Kanagawa (JP); Yuji Suzuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/812,849

(22) Filed: Jun. 22, 2007

(30) Foreign Application Priority Data
Jun. 26, 2006 (JP) 2006-175650

(51) Int. Cl. B29D 7/00

(52) U.S. Cl. 264/216

(57) ABSTRACT

Dope containing TAC and a solvent is prepared. The dope is cast so as to form three layers from a casting die. A casting film is formed on a cooling drum. The casting film is peeled as a wet film from a cooling drum by a peel roller. The wet film is transported by a pin tenter and a clip tenter. A tenter draw ratio, which is a ratio between feeding speeds of the pin tenter and the clip tenter and a rotating speed of the cooling drum, is set to not less than 110% and not more than 150%. The wet film is dried in the pin tenter and the clip tenter to obtain a film.

### FIELD OF THE INVENTION

The present invention relates to a production method of a polymer film suitable for optical use.

### BACKGROUND OF THE INVENTION

A polymer film (hereinafter abbreviated as “film”) has advantages such as excellent light transmission property and flexibility, and is easy to be made lighter and thinner. Accordingly, the film is widely used as an optical functional film. In particular, a cellulose ester film using cellulose acylate or the like further has advantages such as toughness and low birefringence in addition to the above advantages. The cellulose ester film is utilized as a photographic sensitive film, a protective film for a polarizing filter and an optical compensation film as components of a liquid crystal display device (LCD) whose market is increasingly expanded recently.

As a production method of a film, there is a solution casting method. In the solution casting method, dope containing a polymer and a solvent is cast onto a support from a casting die to form a casting film, and the casting film after having a self-supporting property is peeled from the support as a wet film. Then, the wet film is transported in a tenter and dried to form a film. The advantage of the solution casting method is in that it is possible to form a film which is excellent in optical isotropy and thickness uniformity, and which includes few foreign substances. Accordingly, the optical functional film used for the LCD is often formed by the solution casting method.

As for the solution casting method, it is highly desired that productivity of the film is improved by speeding up a casting speed of the dope and a winding speed of the film. However, speeding up the casting speed causes the following troubles in a production process. For example, there occurs unevenness in thickness of the casting film. Additionally, when using a so-called cooling drum having a peripheral surface, onto which dope is cast, adjusted to a temperature lower than a room temperature as a support, it is necessary to speed up a rotating speed of the cooling drum in order to speed up the casting speed. Therefore, flow of air is generated at the vicinity of the cooling drum, and the dope just after being cast includes the air (air entrainment phenomenon). Due to the air entrainment phenomenon, the adhesion of the dope to the cooling drum deteriorates. Further, in a case where the cooling drum is used, when the dope contacts with the cooling drum, unevenness called as a shark skin may occur on the surface of the casting film, depending on the rotating speed of the cooling drum. These troubles may cause deterioration of the quality of a produced film.

In view of the above problems, according to an invention disclosed in Japanese Patent Laid-Open Publication No. 2000-317960, dope is cast so as to form a plurality of layers in a predetermined period of time such that unevenness in thickness is prevented. Further, according to an invention disclosed in Japanese Patent Laid-Open Publication No.2001-18241, dope stably contacts with the support, by use of a suction chamber. Still further, according to an invention disclosed in Japanese Patent Laid-Open Publication No. 11-221833, a tenter draw ratio is set in the range of 1.105 to 1.200 to prevent occurrence of shark skin, thus improving the productivity. Note that the tenter draw ratio (%) means 100×(the feeding speed of the tenter device/the rotating speed of the cooling drum).

In order to further improve the productivity, it is necessary to further increase the tenter draw ratio. On this point, Japanese Patent Laid-Open Publication No. 11-221833 describes that when the tenter draw ratio exceeds 1.200 the optical property of the film is adversely affected. Note that, in Japanese Patent Laid-Open Publications Nos. 2000-317960 and 2001-18241, there is no description about the relation between the invention and the improvement in productivity.

### SUMMARY OF THE INVENTION

An object of the present invention is to provide a production method of a polymer film capable of improving productivity without adversely affecting an optical property of the film.

To achieve the above object, according to the present invention, there is provided a production method of a polymer film including the steps of: casting a plurality of dopes containing a polymer and a solvent so as to be stacked onto a rotating support to obtain a casting film composed of a plurality of layers; cooling and solidifying the casting film; peeling the solidified casting film from the support to obtain a wet film; drying the wet film while transportation thereof in a tenter, the tenter including holding members for holding both side ends of the wet film running along a transporting path to transport the wet film; and setting a tenter draw ratio obtained by a formula 100×x/y to not less than 110% and not more than 150%, the x being a running speed of the holding member and the y being a rotating speed of the support.

Among the plurality of layers, viscosity of the dope for an exposure layer and viscosity of the dope for a contacting layer in contact with the support are preferably lower than viscosity of the dope for an intermediate layer between the exposure layer and the contacting layer. Further, it is preferable that the viscosity of the dope for the intermediate layer is not less than 6.00×10 Pa·s and not more than 10.00×10 Pa·s, and the viscosity of the dope for the exposure layer and for the contacting layer is not less than 3.00×10 Pa·s and not more than 8.00×10 Pa·s. Furthermore, the wet film is preferably transported by a plurality of rollers provided between the support and the tenter. Note that a rotating speed of (n+1)th roller from an upstream side is faster than a rotating speed of nth roller among the rollers (n=natural number).

According to the present invention, it is possible to improve productivity without adversely affecting an optical property and a surface of the film.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a schematic diagram illustrating a first dope production line according to an embodiment of the present invention;

FIG. 2 is a schematic diagram illustrating a casting film and its vicinity according to the embodiment of the present invention;

FIG. 3 is a schematic diagram illustrating a second dope production line according to the embodiment of the present invention; and

FIG. 4 is a schematic diagram illustrating a film production line according to the embodiment of the present invention.

### DESCRIPTION OF THE PREFERRED EMBODIMENTS

Embodiments of the present invention are described hereinbelow. The present invention, however, is not limited to the following embodiments.

### Material

In this embodiment, polymer maybe formed by any film casting method, and cellulose acylate is used as an example of the polymer. Cellulose acylate is especially preferably triacetyl cellulose (TAC). In cellulose acylate, it is preferable that the degree of the acyl substitution for hydrogen atoms in hydroxyl groups in cellulose satisfies all of the following formulae (a) to (c)
2.5≦A+B≦3.0 (a)
0≦A≦3.0 (b)
0≦B≦2.9 (c)
In the above formulae (a) to (c), the A represents a degree of substitution of the hydrogen atom in the hydroxyl group to the acetyl group in cellulose, while the B represents a degree of substitution of the hydrogen atom in the hydroxyl group to the acyl group with 3 to 22 carbon atoms in cellulose. Preferably, at least 90 mass % of TAC particles have a diameter in the range of 0.1 mm to 4 mm, respectively. However, the polymer capable of being used in the present invention is not limited to cellulose acylate.

Cellulose has glucose units making β-1,4 bond, and each glucose unit has a liberated hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose (when the whole (100%) of the hydroxyl group at the same position is substituted, the degree of substitution at this position is 1).

The total degree of substitution for the acyl groups, namely DS2+DS3+DS6, is preferably in the range of 2.00 to 3.00, more preferably in the range of 2.22 to 2.90, and most preferably in the range of 2.40 to 2.88. In addition, DS6/(DS2+DS3+DS6) is preferably at least 0.28, more preferably at least 0.30, and most preferably in the range of 0.31 to 0.34. Note that DS2 is the degree of substitution of the hydrogen atom in the hydroxyl group at second position per glucose unit to the acyl group (hereinafter referred to as a degree of acyl substitution at second position), DS3 is the degree of substitution of the hydrogen atom in the hydroxyl group at third position per glucose unit to the acyl group (hereinafter referred to as a degree of acyl substitution at third position), and DS6 is the degree of substitution of the hydrogen atom in the hydroxyl group at sixth position per glucose unit to the acyl group (hereinafter referred to as a degree of acyl substitution at sixth position).

In the present invention, the kind of the acyl groups in cellulose acylate can be one or more. When two or more kinds of acyl groups are in cellulose acylate, it is preferable that one of them is the acetyl group. When a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.22 to 2.90, and more preferably in the range of 2.40 to 2.88.

In addition, DSB is preferably at least 0.30, and more preferably at least 0.7. In the DSB, the percentage of the substitution of the hydroxyl group at the sixth position is preferably at least 20%, more preferably at least 25%, most preferably at least 30%, and especially preferably at least 33%. Furthermore, the value of DSA+DSB, in which the hydroxyl group is at the sixth position in cellulose acylate, is preferably at least 0.75, more preferably at least 0.80, and most preferably at least 0.85. By using such cellulose acylate that satisfies the above conditions, a solution (dope) with excellent solubility can be prepared. Especially, since using a non-chlorine organic solvent represents excellent solubility, it is possible to produce the dope with low viscosity and excellent filterability.

Although cellulose as a material of cellulose acylate may be obtained from either linter cotton or pulp cotton, the linter cotton is preferably used.

According to the present invention, as for cellulose acylate, the acyl group having at least 2 carbon atoms may be either aliphatic group or aryl group, and is not especially limited. As examples of the cellulose acylate, there are alkylcarbonyl ester, alkenylcarbonyl ester, aromatic carbonyl ester, aromatic alkylcarbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

As a solvent to be used for preparing the dope, there are aromatic hydrocarbon (for example, benzene, toluene, and the like), halogenated hydrocarbon (for example, dichloromethane, chlorobenzene, and the like), alcohol (for example, methanol, ethanol, n-propanol, n-butanol, diethyleneglycol, and the like), ketone (for example, acetone, methylethyl ketone, and the like), ester (for example, methylacetate, ethylacetate, propylacetate, and the like), and the like. Note that in the present invention the dope means a polymer solution or dispersion solution that is obtained by dissolving or dispersing the polymer in the solvent.

The halogenated hydrocarbon preferably has 1 to 7 carbon atoms, and is most preferably dichloromethane. In view of physical properties of the TAC, such as solubility, peelability from the support of a casting film, a mechanical strength of the film, and optical properties, it is preferable to use at least one kind of alcohol having 1 to 5 carbon atoms together with dichloromethane. The content of alcohol is preferably in the range of 2 mass % to 25 mass %, and more preferably in the range of 5 mass % to 20 mass % relative to the whole solvent. Applicable alcohols are, for example, methanol, ethanol, n-propanol, iso-propanol, n-butanol, and the like, and especially methanol, ethanol, n-butanol, and a mixture of them are more preferable among them.

Recently, in order to reduce adverse influence on the environment to the minimum, a solvent containing no dichloromethane is proposed. In this case, the solvent preferably contains ether with 4 to 12 carbon atoms, ketone with 3 to 12 carbon atoms, ester with 3 to 12 carbon atoms, alcohol with 1 to 12 carbon atoms, or a mixture of them. For example, there is a mixed solvent of methylacetate, acetone, ethanol, and n-butanol. Note that ether, ketone, ester, and alcohol may have a cyclic structure. A compound having at least two functional groups thereof (that is, —O—, —CO—, —COO—, and —OH) may be used as the solvent.

Details regarding cellulose acylate are described in paragraphs [0140] to [0195] in Japanese Patent Laid-Open Publication No. 2005-104148. The description is also applicable to the present invention. Further, details regarding the solvents and the additives (such as a plasticizer, a deterioration inhibitor, a UV-absorbing agent, an optical anisotropy controller, a retardation controller, dye, a matting agent, a release agent, a release improver, and the like) are also described in paragraphs [0196] to [0516] in the same publication. The description is also applicable to the present invention.

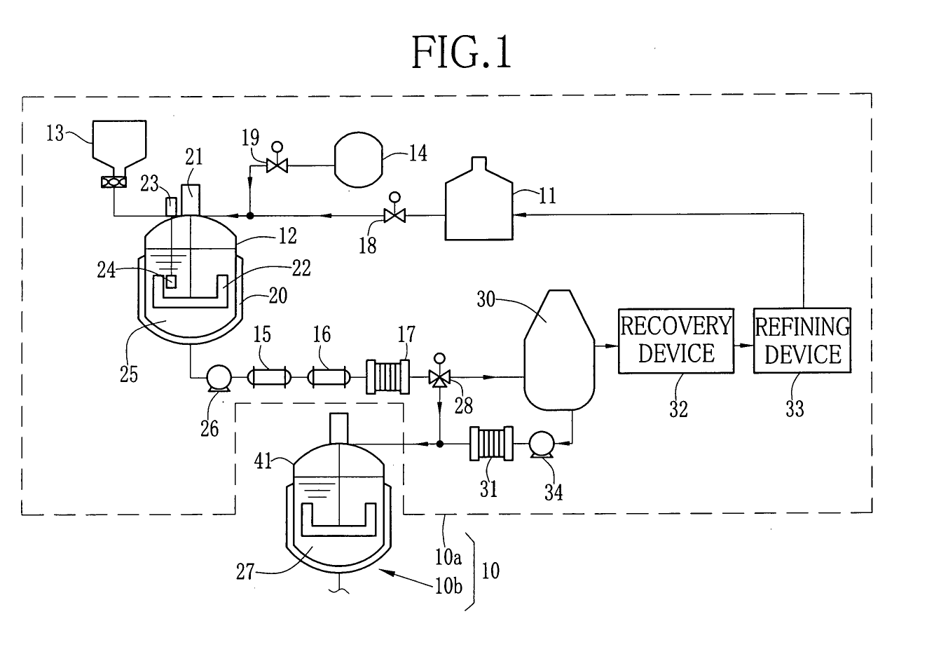

As shown in FIG. 1, dope is produced in a dope production line 10 using the above materials. The dope production line 10 is composed of a first dope production line 10a for preparing dope 27 by dissolving the TAC into the solvent, and a second dope production line 10b for casting the prepared dope 27 so as to form a plurality of layers.

As shown in FIG. 1, the first dope production line 10a includes a solvent tank 11 for storing the solvent, a mixing tank 12 for mixing the solvent and TAC or the like, a hopper 13 for supplying the TAC, an additive tank 14 for storing an additive, a heater 15 for heating a swelling liquid, a temperature regulator 16, a filtration device 17, a flash device 30 for concentrating the prepared dope 27, a filtration device 31, a recovery device 32 for recovering the solvent, and a refining device 33 for refining the recovered solvent. The first dope production line 10a is connected to a stock tank 41 included in the second dope production line 10b.

In the first dope production line 10a, there are performed a dope preparation process, a filtration process, a concentration process, and a refinement process. The dope 27 prepared in the dope preparation process is sent to the concentration process or the stock tank 41 after passing the filtration process. The solvent refined in the refinement process is sent to the solvent tank 11 to be reused in the dope preparation process.

In the dope preparation process, the dope 27 is prepared. First of all, a valve 18 is opened, and the solvent is sent from the solvent tank 11 to the mixing tank 12. Next, the TAC stored in the hopper 13 is supplied to the mixing tank 12 while its mount is measured. A predetermined amount of additive liquid is supplied to the mixing tank 12 from the additive tank 14 by opening/closing a valve 19.

In a case where the additive is liquid at room temperature, it is possible to send the additive to the mixing tank 12 in a liquid state, in addition to supplying as solution. Further, in a case where the additive is solid, the hopper or the like can be used to supply the additive to the mixing tank 12. Further, in a case where plural kinds of additives are to be added, it is also possible to dissolve the plural kinds of additives in the additive tank. Additionally, it is possible that plural additive tanks are used in accordance with the kinds of the solutions containing each additive, and each additive is supplied to the mixing tank 12 through independent pipes.

Although it is preferable that the solvent, the TAC, and the additive are supplied to the mixing tank 12 in this order, the order is not limited thereto. For example, after supplying the TAC to the mixing tank 12 while measuring its amount, the solvent may be supplied thereto. Further, it is not always necessary to preliminarily supply the additive to the mixing tank 12, and the additive may be mixed with a mixture of the TAC and the solvent in the following process.

The mixing tank 12 is provided with a jacket 20 for covering an outer surface thereof, a first stirrer 22 rotated by a motor 21, and a second stirrer 24 rotated by a motor 23. The temperature of the mixing tank 12 is regulated by pouring a heat transfer medium (not shown) into the jacket 20. A preferable temperature range of the mixing tank 12 is not less than −15° C. and not more than 55° C. The first stirrer 22 and the second stirrer 24 are arbitrarily selected and used to prepare a swelling liquid 25 in which the TAC is swelled in the solvent. Note that the first stirrer 22 is preferably provided with an anchor blade, and the second stirrer 24 is preferably a decentering stirrer of dissolver type.

The swelling liquid 25 prepared in the mixing tank 12 is supplied to the heater 15 by a pump 26. The heater 15 includes a pipe provided with a jacket, and heats the swelling liquid 25. The preferable temperature range of the swelling liquid 25 is not less than 50° C. and not more than 120° C. By use of the heater 15, solid contents in the swelling liquid 25 is dissolved to prepare the dope 27. The temperature of the prepared dope 27 is regulated by the temperature regulator 16 such that the temperature of the dope 27 becomes approximately a room temperature. Note that it is also possible to perform a cool-dissolving method in which the swelling liquid 25 is cooled to not less than −100° C. and not more than −30° C. to be dissolved.

In the filtration process, the dope 27 is filtered to remove impurities in the dope 27. After passing the temperature regulator 16, the dope 27 is filtered by the filtration device 17 to remove impurities, foreign substances, and the like. Thereafter, the dope 27 is supplied to the stock tank 41 or the flash device 30 via a valve 28. Note that an average diameter of the pores of a filtration filter used for the filtration device 17 is preferably not more than 10 μm. The filtering flow rate is preferably equal to or more than 50 L/h.

In the concentration process, the dope 27 is concentrated. As described above, the method for preparing the dope 27 after producing the swelling liquid 25 takes longer time when the concentration of the dope 27 to be produced is higher. Therefore, there arises a problem in that the manufacturing cost increases. In view of the above, in the concentration process, in order to avoid the problem, after the dope 27 having a concentration lower than a desired concentration is prepared in the dope preparation process describes above, the dope 27 having a low concentration is concentrated by the flash device 30 to obtain the dope 27 having a desired concentration. The flash device 30 evaporates a part of the solvent in the dope 27 supplied via the valve 28. The content of the solvent in the dope 27 decreases by the evaporation, thus increasing the concentration of the dope 27. The dope 27 thus concentrated is taken out of the flash device 30 by a pump 34. The dope 27 thus taken out is fed into the filtration device 31 to be filtrated, and then sent to the stock tank 41. Note that when the dope 27 is to be taken out of the flash device 30, it is preferable that a defoaming process is performed in order to remove the bubbles contained in the dope 27. As the deforming process, various well-known methods are applicable. For example, there is an ultrasonic irradiation method.

In the refinement process, the solvent evaporated in the flash device 30 is refined. Solvent gas generated due to the evaporation of the solvent in the flash device 30 is condensed to be liquidized by a condenser (not shown) in the flash device 30, and recovered by the recovery device 32. The recovered solvent is refined by the refining device 33 as a solvent for preparing the dope. The refined solvent is sent to the solvent tank 11.

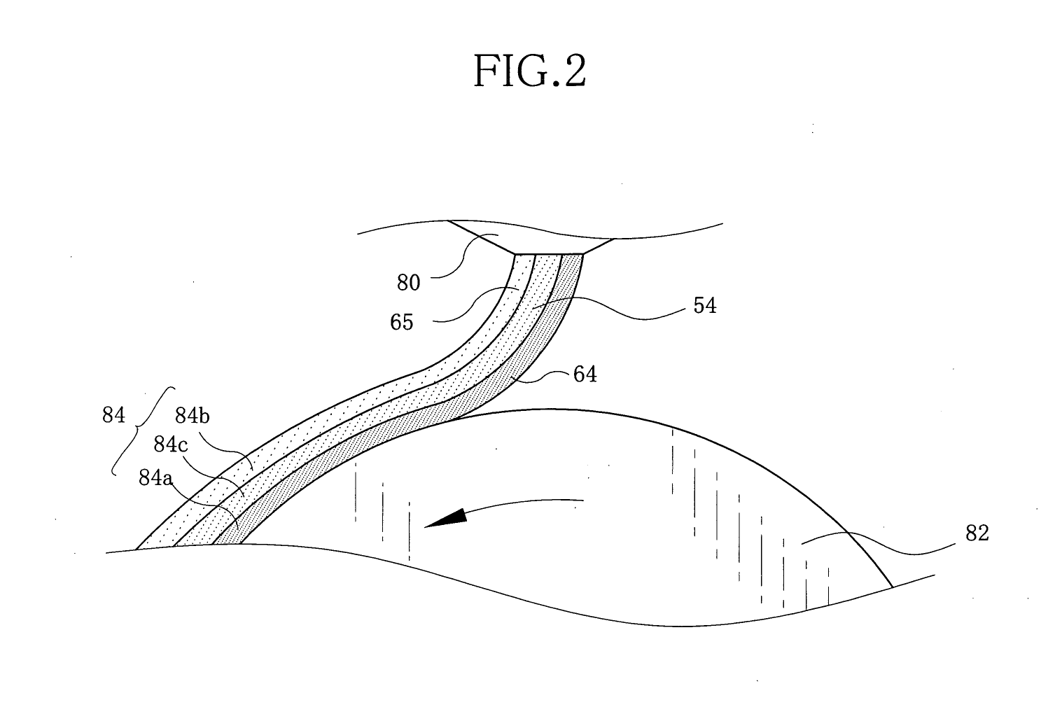

A method for forming a three-layered casting film from the dope 27 is explained. As shown in FIG. 2, the casting film 84 includes a contacting layer (hereinafter referred to as support layer) 84a contacting a cooling drum 82 as the support, an exposure layer (hereinafter referred to as outer layer) 84b, and an intermediate layer 84c between the support layer 84a and the outer layer 84b.

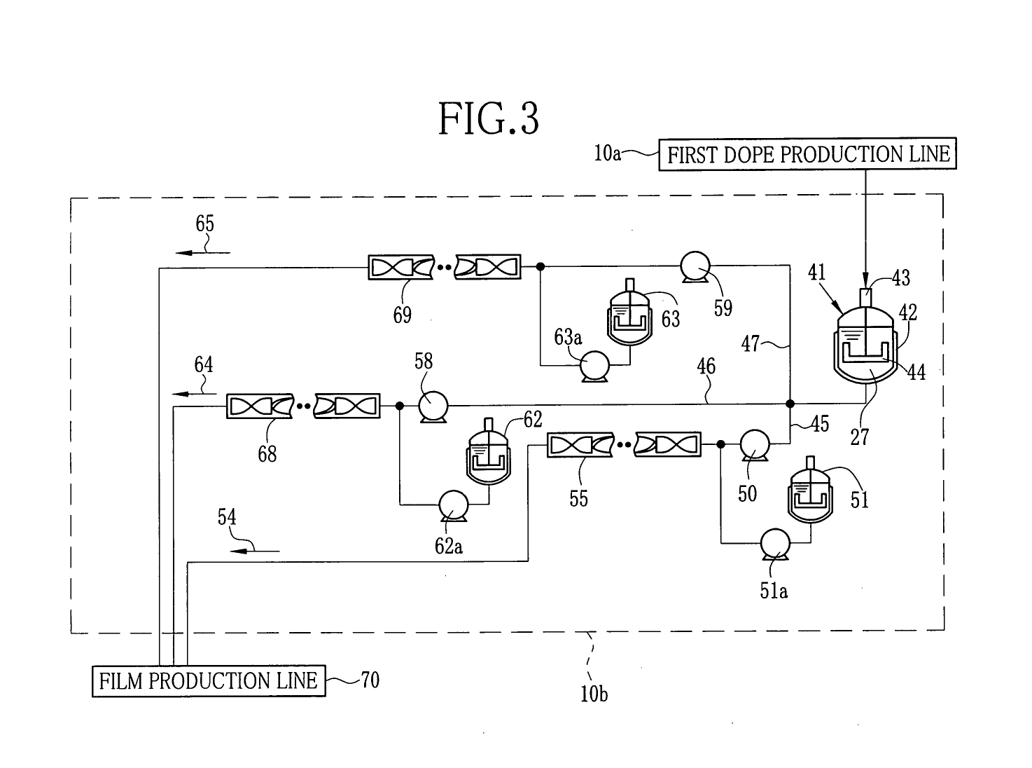

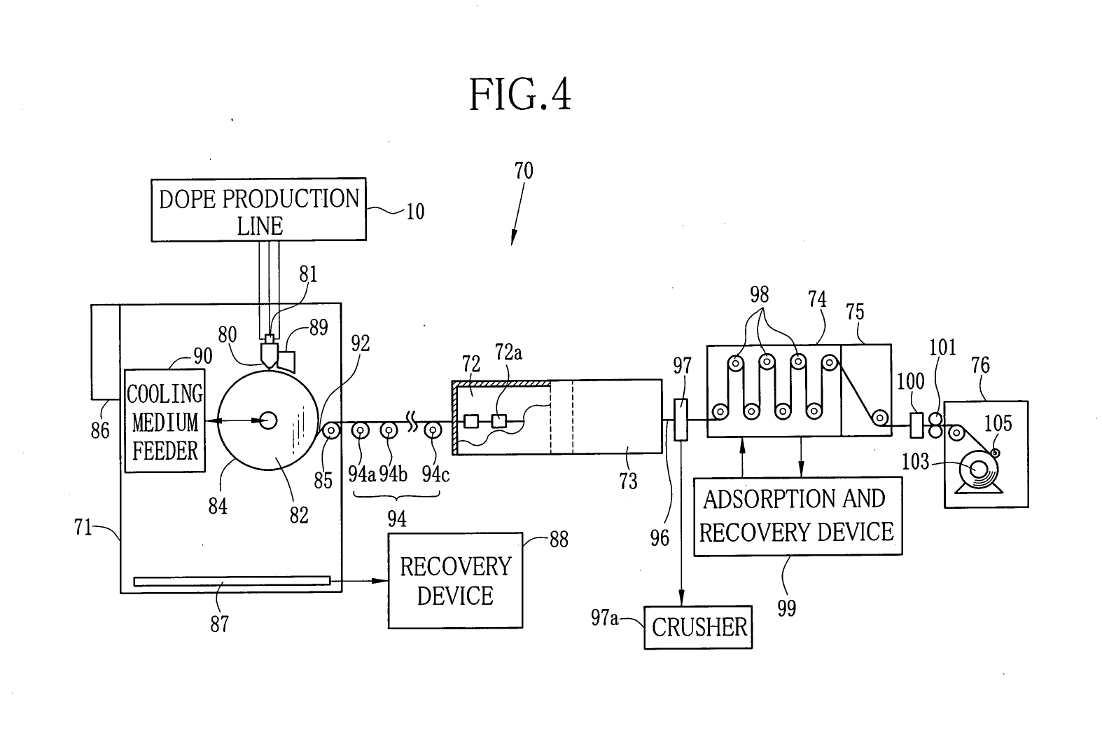

As shown in FIG. 3, the second dope production line 10b connects the first dope production line 10a and a film production line 70. The stock tank 41 in the second dope production line 10b is connected to the first dope production line 10a to store the dope 27 prepared in the first dope production line 10a. A liquid feed pipe branching into three channels 45 to 47 is connected to the stock tank 41. The flow channels 45 to 47 are connected to a feed block 81 (see FIG. 4) of the film production line 70, respectively. That is, the second dope production line 10b feeds the dope 27 prepared in the first dope production line 10a to the film production line 70 through the flow channels 45 to 47. Among the flow channels 45 to 47, a support layer dope channel 45 is a flow channel for support layer dope 54 for forming a support layer 84a (see FIG. 2), an outer layer dope channel 47 is a flow channel for outer layer dope 65 for forming an outer layer 84b (see FIG. 2), and an intermediate layer dope channel 46 is a flow channel for intermediate dope 64 for forming an intermediate layer 84c (see FIG. 2).

The stock tank 41 is provided with a jacket 42 for covering an outer surface thereof, a stirrer 44 rotated by a motor 43. Although not shown, heat transfer medium flows in the jacket 42, and thereby the temperature in the stock tank 41 is regulated at a predetermined value.

A pump 50 is connected to the support layer dope channel 45. The dope 27 flows from the stock tank 41 in the support layer dope channel 45 by the pump 50. An additive is added to the dope 27 from a support layer additive tank 51 by a pump 51a in an in-line manner. The dope 27 and the additive are stirred and mixed by a static mixer 55 located in a downstream from the pump 50. Thus, the support layer dope 54 is obtained. The viscosity of the support layer dope 54 (unit; Pa·s) is preferably in the range of 3.00×10 Pa·s to 8.00×10 Pa·s, and more preferably in the range of 4.00×10 Pa·s to 8.00×10 Pa·s. The support layer dope 54 is supplied to the feed block 81 (see FIG. 4) and cast together with the intermediate layer dope 64 and the outer layer dope 65.

The additive to be stored in the support layer additive tank 51 is a release improver (citrate ester) for facilitating the release of the casting film 84, a matting agent (such as silicon dioxide) for suppressing the adhesion between the surfaces of the film in winding a film in a roll manner, or the like.

A pump 58 is disposed in the intermediate layer dope channel 46, and a pump 59 is disposed in the outer layer dope channel 47. The dope 27 is flown from the stock tank 41 in the dope channels 46 and 47 by the pumps 58 and 59, respectively. The additives in an intermediate layer additive tank 62 and an outer layer additive tank 63 are added to the dope 27 by pumps 62a and 63a, respectively in an in-line manner. The viscosity of the intermediate layer dope 64, to which the additive in the intermediate layer additive tank 62 is added, is set larger than that of the outer layer dope 65, to which the additive in the outer layer additive tank 63 is added. Specifically, the viscosity of the intermediate layer dope 64 is preferably in the range of 6.00×10 Pa·s to 10.00×10 Pa·s, and more preferably in the range of 5.00×10 Pa·s to 10.00×10 Pa·s. The viscosity of the outer layer dope 65 is preferably in the range of 3.00×10 Pa·s to 8.00×10 Pa·s, and more preferably in the range of 4.00×10 Pa·s to 8.00×10 Pa·s. The dope 27 and the additives in the intermediate layer additive tank 62 and the outer layer additive tank 63 are stirred and mixed by static mixers 68 and 69 located in the downstream from the pumps 58 and 59, respectively. The intermediate layer dope 64 and the outer layer dope 65 thus obtained are sent to the feed block 81 (see FIG. 4) located in the downstream from the static mixers 68 and 69, respectively.

The additive to be stored in the intermediate layer additive tank 62 is a plasticizer such as triphenyl phosphate and biphenyl diphenyl phosphate, a UV-absorbing agent, or the like. The additive to be stored in the outer layer additive tank 63 is the above-described additive to be stored in the intermediate layer additive tank 62, colloidal silica, a deterioration inhibitor, or the like.

Note that, when the casting film has a structure composed of more than four layers, it is preferable to provide plural intermediate layers 84c. In this case, it is preferable to set the viscosity of the dope for forming at least one of the intermediate layers among the plural intermediate layers larger than that of the support layer dope 45 and the outer layer dope 65. It is more preferable to set the viscosity of the dope for forming a layer located in the dead center position in the thickness direction of the casting film 84 among the plural intermediate layers larger than that of the support layer dope 45 and the outer layer dope 65.

Hereinafter, a method of producing a film using the dope 27 obtained as described above is explained. As shown in FIG. 4, the film production line 70 includes a casting chamber 71, a pin tenter 72, a clip tenter 73, a drying chamber 74, a cooling chamber 75, and a winding chamber 76.

The casting chamber 71 includes a casting die 80 from which the dope 27 is cast, the feed block 81 which is attached to the casting die 80 and combines dopes 54, 64, and 65 sent from the dope production line 10, the cooling drum 82 as the support, a peel roller 85 for peeling the casting film 84 from the cooling drum 82, a temperature controller 86 for controlling the temperature inside the casting chamber 71, and a condenser 87 for liquidizing solvent vapor in the casting chamber 71. The solvent vapor condensed and liquidized in the condenser 87 is recovered by the recovery device 88 and refined by the refining device (not shown) to be reused as the solvent for preparing the dope. Further, the casting die 80 is provided with a suction chamber 89 for sucking air and decreasing pressure to decompress the rear portion (namely, the downstream side ) of the casting die 80 and its vicinity to a desired pressure.

The cooling drum 82 is rotated by a driver (not shown). The cooling drum 82 is provided with a cooling medium feeder 90 for keeping the surface temperature of the cooling drum 82 at a desired value. The cooling medium having the temperature adjusted at a desired value is supplied from the cooling medium feeder 90 to the inside of the cooling drum 82 to be circulated therein or pass therethrough. Thereby, the dope 27 thus cast is cooled and turned into a gel-like state to form the casting film 84. As being turned into a gel-like state, the casting film 84 has a self-supporting property. Thereafter, the casting film 84 is peeled from the cooling drum 82 by the peel roller 85, thus forming a wet film 92.

A plurality of pass rollers 94 are disposed between the casting chamber 71 and the pin tenter 72. The pass rollers 94 guide the wet film 92, obtained by peeling the casting film 84 from the cooling drum 82, to the pin tenter 72. Although not shown, a dry air supplying device is provided above the pass rollers 94. The dry air supplying device blows dry air against the wet film 92 on the pass rollers 94, thus drying the wet film 92.

The pin tenter 72 has holding members 72a, and each of the holding members 72a is a base for a plurality of pins (not shown). Both side ends of the wet film 92 are pierced by the pins, and the wet film 92 is transported by a belt (not shown). Further, in the pin tenter 72, the drying of the wet film 92 proceeds, to decrease the amount of remained solvent and obtain a film 96 from the wet film 92. The clip tenter 73 is disposed in the downstream from the pin tenter 72. The clip tenter 73 holds the both side ends of the film 96 sent from the pin tenter 72, and transports the film 96, to dry the film 96.

An edge slitting device 97 is disposed in the downstream from the clip tenter 73. The edge slitting device 97 cuts off the side ends of the film 96. The both side ends of the film 96 thus cut away are fed into a crusher 97a provided in the edge slitting device 97 and crushed into pieces therein. The film after the side edges thereof are cut off is fed into the drying chamber 74 located in the downstream from the edge slitting device 97.

The drying chamber 74 is provided with a plurality of rollers 98. The film 96 is transported by the rollers 98 to be dried in the drying chamber 74. The solvent gas generated from the film 96 in the drying chamber 74 is recovered and absorbed by an adsorption and recovery device 99 disposed outside of the drying chamber 74.

After going out of the drying chamber 74, the film 96 is fed into the cooling chamber 75 to be cooled until the temperature thereof becomes approximately a room temperature therein. In the downstream from the cooling chamber 75, there is provided a compulsory neutralization device (neutralization bar) 100 for regulating the voltage applied to the film 96 in a predetermined range (for example, in the range of −3 kV to 3 kV). In the downstream from the compulsory neutralization device (neutralization bar) 100, there is provided a knurling roller 101 for forming knurling on both ends of the film 96 by performing emboss processing. The film 96 after the knurling is wound by a winding roller 103 included in the winding chamber 76. A press roller 105 for controlling tension to be applied to the film 96 is disposed at the vicinity of the winding roller 103.

Next, producing conditions in the film production line 70 are explained. The temperature in the casting chamber 71 is preferably set in the range of −10° C. to 57° C. by the temperature controller 86. The surface temperature of the cooling drum 82 is preferably set in the range of −50° C. to 0° C. by the cooling medium feeder 90.

A tenter draw ratio is a ratio between feeding speeds V1 (unit; m/min) of the pin tenter 72 and the clip tenter 73 and a rotating speed V2 (unit; m/min) of the cooling drum 82. The tenter draw ratio is preferably in the range of 110% to 150%, and more preferably in the range of 120% to 150%. Here, the tenter draw ratio (%) is represented as 100×V1/V2. In Japanese Patent Laid-Open Publication No. 11-221833, there is described that when the tenter draw ratio is 120% or more the optical properties of the film is adversely affected. However, according to the present invention, even when the tenter draw ratio is in the range of 120% to 150%, front retardation (Re) and retardation in the thickness direction (Rth) as values representing the optical properties are within the range of Re and Rth of the cellulose ester film suitable for optical use. Moreover, even when the tenter draw ratio is increased to 150%, there arises no shark skin. Note that, when the tenter draw ratio is less than 110%, it is not possible to achieve desired productivity. Additionally, when the tenter draw ratio is more than 160%, the wet film may be broken.

Rotating speed V3 (unit; m/min) of the pass roller 94 is a value in the range of the rotating speed V2 to the feeding speed V1. Further, the pass roller 94 is compose of three pass rollers 94a, 94b, and 94c, and the rotating speed V3 of each pass roller 94a, 94b, and 94c is configured to gradually increase from a side of the cooling drum 82 to a side of the pin tenter 72 within the above range. For example, when a pass roller draw ratio is the ratio of the rotating speed V3 of the pass roller 94 to the rotating speed V2 of the cooling drum 82, the pass roller draw ratio (%) is represented as 100×V3/V2. When the tenter draw ratio is 130%, the pass roller draw ratio of the pass roller 94a at the side of the cooling drum 82 is set to 105%, that of the pass roller 94b adjacent to the pass roller 94a is set to 112%, and that of the pass roller 94c at the side of the pin tenter 72 is set to 120%. Note that the three pass rollers 94a, 94b, and 94c are disposed in this order from the upstream side of a transporting path (not shown) from the cooling drum 82 to the pin tenter 72. Since the rotating speeds V3 of the pass rollers 94 gradually increase in the above manner, it is possible to gradually draw the wet film 92 without rapidly drawing the wet film 92 just after being peeled off. Therefore, even when the tenter draw ratio is made larger, the wet film 92 is not broken.

Note that, although the wet film 92 is transported to be dried by use of the pin tenter 72, it is also possible to provide the clip tenter 73 in the downstream from the pin tenter 72 and further dry the film.

### Properties And Measuring Method

Degree of Curling And Thickness

The properties of the cellulose acylate film wound up and the measuring method thereof are described in paragraphs [1073] to [1087] in Japanese Patent Laid-Open Publication No. 2005-104148. The description is also applicable to the present invention.

Surface Treatment

At least one of the surfaces of the cellulose acylate film is preferably subjected to a surface treatment. The surface treatment is preferably at least one of vacuum glow discharge, plasma discharge under the atmospheric pressure, UV-light irradiation, corona discharge, flame treatment, acid treatment, and alkali treatment.

Functional Layer

Antistatic, Hardened Layer, Antireflection, Easily Adhesion, And Antiglare Function

At least one of the surfaces of the cellulose acylate film may be subjected to an undercoating process.

It is preferable that the cellulose acylate film is the base film and used as a functional material including other functional layers. As the functional layer, it is preferable that there is provided one of an antistatic layer, a hardened resin layer, antireflection layer, an easily adhesive layer, an antiglare layer, and an optical compensation layer. The functional layer preferably contains at least one kind of each of surfactants, lubricants, and matting agents in the range of 0.1 mg/m² to 1000 mg/m² each. More preferably, the functional layer contains at least one kind of antistatic agents in the range of 1 mg/m² to 1000 mg/m². Note that, other than the above, a method of forming the surface treatment functional layer for providing the cellulose acylate film with various functions and properties, detailed conditions thereof, and detailed methods are described in paragraphs [0890] to [1072] in Japanese Patent Laid-Open Publication No. 2005-104148. The description is also applicable to the present invention.

Applications of the film obtained according to the present invention are described hereinafter. The film obtained according to the present invention has a high retardation value and excellent transparency to be effectively used as particularly a protective film for a polarizing filter. Note that a liquid crystal display obtained by adhering two polarizing filters, in which the film is attached to a polarizer, to a liquid crystal layer represents features such as excellent capability of displaying liquid crystal or the like. However, the location of the liquid crystal layer and the polarizing filter is not especially limited, and may be located in an arbitrary position based on a various known locations. Details regarding the liquid crystal displays of TN type, STN type, VA type, OCB type, reflective type, and other types are described in Japanese Patent Laid-Open Publication No. 2005-104148 (for example, in paragraphs [1088] to [1265]). The description is also applicable to the present invention. Additionally, in the same publication, there are described a cellulose acylate film provided with an optically anisotropic layer, a cellulose acylate film provided with antireflective and antiglare functions, and applications of an optical compensation film as a biaxial cellulose acylate film provided with adequate optical properties. The biaxial cellulose acylate film also may be combined together with a protective film for a polarizing filter. The descriptions are also applicable to the present invention. Further, the film obtained according to the present invention can be used as a support for photography.

Hereinafter, the present invention is described in detail referring to Examples. However, the present invention is not limited to these Examples.

### EXAMPLE 1

The parts by mass of materials used in Example 1 are as follows. Note that, as the solvent for preparing the dope, dichloromethane (first component of the solvent), methanol (second component of the solvent), and n-butanol (third component of the solvent) were preliminarily mixed to be a mixed solvent and stored in the solvent tank 11.

| | | |
|---|---|---|
| cellulose triacetate (powder having degree of | 100 | parts by mass |
| substitution of 2.86, viscosity average | | |
| polymerization degree of 306, water content of | | |
| 0.2 mass %, viscosity in dichloromethane solution | | |
| of 6 mass % of 315 m Pa · s, average particle | | |
| diameter of 1.5 mm, and standard deviation of | | |
| particle diameter of 0.5 mm) | | |
| dichloromethane (first component of the solvent) | 397 | parts by mass |
| methanol (second component of the solvent) | 75 | parts by mass |
| n-butanol (third component of the solvent) | 3 | parts by mass |
| plasticizer A (triphenyl phosphate) | 7.6 | parts by mass |
| plasticizer B (diphenyl phosphate) | 3.8 | parts by mass |
| UV agent a: 2-(2′-hydroxy-3′,5′-di-tert- | 0.7 | parts by mass |
| butylphenyl) benzotriazole | | |
| UV agent b: 2-(2′-hydroxy-3′,5′-di-tert- | 0.3 | parts by mass |
| amylphenyl)-5-chlorbenzotriazole | | |
| fine particles (silicon dioxide (average | 0.05 | parts by mass |
| particle diameter of 15 nm, Mohs hardness of | | |
| approximately 7) | | |

Note that, in cellulose triacetate used in this example, the residual amount of acetic acid was equal to or less than 0.1 mass %, the rate of content of Ca was 80ppm, the rate of content of Mg was 42ppm, the rate of content of Fe was 0.5ppm, the rate of content of free acetic acid was 40ppm, and the rate of content of sulfate ion was 15ppm. When extraction of cellulose triacetate was applied with acetone, the extract content was 8 mass %. A proportion of weight-average molecular weight to number average molecular weight was 2.7. Note that a yellow index of the obtained cellulose triacetate was 6.0, the haze thereof was 0.08, the transparency thereof was 93.5%, Tg (glass transition temperature) measured by a differential scanning calorimetry (DSC) was 160° C., and calorific value of crystallization thereof was 6.4 J/g. Cellulose triacetate used in this example was synthesized from cellulose that was extracted from pulp.

The dope 27 for casting was prepared in the first dope production line 10a shown in FIG. 1. The mixed solvent containing the first to third solvents was supplied from the solvent tank 11 to the mixing tank 12 whose content was 4000 L and which was made of stainless. The first stirrer 22 and the second stirrer 24 were disposed in the mixing tank 12. TAC was supplied from the hopper 13 to the mixing tank 12 such that the total weight of the mixing tank 12 became 2000 kg. Each of the solvent used in this example had water content of 0.5 mass % or less. The second stirrer 24 having a stirrer of dissolver type was caused to stir the inside of the mixing tank 12 at a peripheral speed of 5 m/s (shearing stress: 5×9.8×10⁴V/m/s²) at first. Thereafter, the first stirrer 22 having an anchor blade at its central shaft was caused to stir at a peripheral speed of 1 m/s (shearing stress: 1×9.8×10⁴N/m/s²) to disperse the TAC powder into the mixed solvent for 30 minutes. Note that the temperature at the time of starting dispersing was 25° C., and the temperature finally rose to 48° C. After the dispersion, high-speed stirring was stopped and the peripheral speed of the first stirrer 22 was switched to 0.5 m/s to stir for 100 minutes. Thereafter, the flaky cellulose triacetate was swelled to obtain the swelling liquid 25. Note that, until the swelling was completed, nitrogen gas was fed into the mixing tank 12 to pressurize the inside thereof to 0.12 MPa. Further, the oxygen concentration inside the mixing tank 12 was regulated to less than 2 vol % to maintain a safe state in view of explosion proof. The proportion of water contained in the swelling liquid 25 was 0.3 mass %.

The swelling liquid 25 was supplied from the mixing tank 12 to the heater 15 by a pump 26 to heat the swelling liquid 25 to 50° C. Then, the swelling liquid 25 was heated to 90° C. under pressurization of 2MPa to completely dissolve the TAC into the solvent. Note that the heating time was 15 minutes. Then, the solution was supplied to the temperature regulator 16 to decrease the temperature thereof to 36° C. The solution was caused to pass the filtration device 17 having a film with pores whose nominal diameter each was 8 μm, thus removing foreign substances in the solution to obtain the dope (dope before concentration). Note that a primary pressure was 1.5 MPa and a secondary pressure was 1.2 MPa in the filtration device 17. The pipes connecting the respective devices and the filter, which were subjected to high temperature, were made of Hastelloy alloy (trade name).

The dope before concentration was fed into the flash device 30 controlled at a condition of a normal pressure and 80° C., and subjected to flash evaporation to be concentrated, thus obtaining the dope 27. The solid content degree of the dope 27 after flash evaporation was 22.5 mass %. At this time, the solvent having evaporated due to the concentration was recovered by the recovery device 32 and refined by the refining device 33. Thereafter, the refined solvent was fed into the solvent tank 11 and reused as the solvent for preparing dope. Note that distillation and dehydration were performed in the recovery device 32 and the refining device 33. A flash tank of the flash device 30 was provided with a stirrer (not shown). A stirring shaft of the stirrer included an anchor blade. The dope 27 after flash evaporation was stirred by the stirrer at a peripheral speed of 0.5 m/s to be defoamed. The temperature of the dope 27 in the flash tank was 25° C., and the average retention time of the dope 27 in the flash tank was 50 minutes. The dope 27 after concentration was picked to measure its shearing viscosity at the temperature of 25° C. The measured shearing viscosity at a shearing speed of 10 sec-¹ was 450 Pa·s.

The dope 27 after concentration was irradiated by weak ultrasonic wave to be defoamed. Thereafter the dope 27 pressurized to 1.5 MPa was fed into the filtration device 31 by the pump 34 and filtered therein. In the filtration device 31, the dope 27 was caused to pass a sintered fiber metal filter with pores whose nominal diameter each was 10 μm, and then was caused to pass a sintered fiber filter with pores whose nominal diameter each was 10 μm. At this time, primary pressures of the respective filtrations were 1.5 MPa and 1.2 MPa, and secondary pressures of the respective filtrations were 1.0 MPa and 0.8 MPa. After the filtration, the dope 27 with its temperature adjusted to 36° C. was fed into the stock tank 41 whose content was 2000 L and which was made of stainless to be stored therein. In the stock tank 41, the dope 27 was constantly stirred by the stirrer with the anchor blade at its central shaft at a peripheral speed of 0.3 m/s.

The dope 27 prepared in the first dope production line 10a was pored into three flow channels including the support layer dope channel 45, the intermediate layer dope channel 46, and the outer layer dope channel 47. The support layer dope 54 with viscosity of 5.00×10 Pa·s, to which the additive for preparing the dope composition was added from the support layer additive tank 51, was pored to the film production line 70. Further, the intermediate layer dope 64 with viscosity of 8.00×10 Pa·s, to which the additive for preparing the dope composition was added from the intermediate layer additive tank 62, was pored to the film production line 70. Further, the outer layer dope 65 with viscosity of 5.00×10 Pa·s, to which the additive for preparing the dope composition was added from the outer layer additive tank 63, was pored to the film production line 70.

The casting die 80 cast the dope 27 while adjusting the amount thereof such that the thickness of the film 96 became 80 μm. The width of the casting die was 1700 μm. The casting speed was 20 m/m. The casting die 80 was provided with a jacket (not shown), and the inlet temperature of the heat transfer medium to be supplied to the jacket was set to 36° C. to adjust the temperature of the dope 27 to 36° C.

The casting die 80 was a coat-hanger type die and provided with thickness adjusting bolts (not shown) at a pitch of 20 mm. Further, the casting die 80 was provided with an automatic thickness adjusting mechanism (not shown) utilizing heat bolts. The heat bolts could perform feedback control by an infrared thickness gauge (not shown) disposed inside the film production line 70 to adjust the thickness.

The casting die 80 was provided with a suction chamber 89. The decompression degree of the suction chamber 89 was adjusted such that the pressure difference between the casting bead in the upstream side from the casting die and the casting bead in the downstream side from the casting die was in the range of 1 Pa to 5000 Pa. The adjustment was performed in accordance with the casting speed. At this time, the pressure difference between the side surfaces of the casting bead was set such that the length of the casting bead was in the range of 20 mm to 50 mm. The pressure of the casting bead in the downstream side from the casting die was lower than that in the upstream side from the casting die by 150 Pa by the suction chamber 89. The suction chamber 89 was provided with a mechanism capable of being set at a temperature higher than the condensation temperature of the gas at the vicinity of the casting portion. The casting die 80 was further provided with an edge suction device (not shown) for regulating disturbance of the both side ends of the casting bead. The edge suction device was arbitrarily adjusted such that the air rate supplied to the edge became in the range of 1 L/m to 100 L/m. The suction chamber 89 was provided with a jacket (not shown) with its temperature adjusted to 35° C. by the heat transfer medium. The jacket maintained the temperature inside the suction chamber 89 at a constant value.

The cooling drum 82 whose width was 2.1 m and which was made of stainless was used as the support. The surface of the cooling drum 82 was ground such that the surface roughness became 0.05 μm or less. The cooling drum 82 had resistance to low temperature, resistance to corrosion, and strength sufficiently. The rotating speed V2 of the cooling drum 82 was changed such that the tenter draw ratio became in the range of 100% to 160% in order to evaluate the produced film. Further, the cooling drum 82 was controlled by detecting the end positions thereof such that the meandering thereof in the width direction per one rotation was limited to 1.5 mm or less. Cooling medium at −30° C. was supplied to the cooling drum 82 by the cooling medium feeder 90, and circulated therein, such that the surface temperature of the cooling drum 82 became −5° C. Note that the variation in location in a vertical direction of the front end of the die lip and the cooling drum 82 just below the casting die 80 was adjusted so as to be 200 μm or less. The cooling drum 82 was disposed in the casting chamber 71 having a device for suppressing fluctuation in air pressure (not shown).

The cooling drum 82 preferably had no surface defect, and there was no pinhole having a diameter of 30 μm or more. There was one or less pinhole having a diameter of 10 μm to 30 μm per m². There were two or less pinholes each having a diameter of less than 10 μm per m². The temperature of the casting chamber 71 was retained at 35° C. by the temperature controller 86. In order to condense and recover the solvent gas in the casting chamber 71, the condenser 87 was disposed, and the outlet temperature thereof was set to −10° C. Additionally, an air blower (not shown) was disposed in the casting chamber 71 to blow dry air at 40° C. and 10% RH against the casting film 84 at wind velocity of 10 m/min.

At the time when the residual amount of the solvent in the casting film 84 became 150 mass % on a dry basis, the casting film 84 was peeled from the cooling drum 82 as the wet film 92 by the peel roller 85. The temperature of the casting film 84 at this time was −10° C. The time for which the casting film 84 was transported on the cooling drum 82 was 3 seconds. The peeling tension applied thereto was 1.0×9.8×10²N/m. Note that average drying speed of the casting film 84 on the cooling drum 82 was 60 mass %/m on a dry basis. In this embodiment, the solvent gas generated due to the drying was condensed and liquidized by the condenser 87 set at −10° C. to be recovered by the recovery device 88. The recovered solvent was adjusted by being subjected to moisture removing process and reused as a solvent for preparing the dope. At this time, the water content of the solvent was adjusted to 0.5% or less.

Next, the wet film 92 was fed to the pin tenter 72 and the clip tenter 73 via the rotating pass rollers 94. The wet film 92 was dried while being transported in the pin tenter 72 and the clip tenter 73 to obtain the film 96. The feeding speed V1 of the pin tenter 72 and the clip tenter 73 was changed such that the tenter draw ratio became in the range of 100% to 160% in order to evaluate the produced film.

The edge slitting device 97 cut off the side ends of the film 96. The edge slitting device 97 was a NT-type cutter, and cut off portions each having a length of 50 mm from the side ends of the film 96. The both side ends of the film 96 thus cut away were fed into a crusher 97a by a cutter blower (not shown) to be crushed into chips each of which was approximately 80 mm² on average and stored in a silo for side edges (not shown). A solvent densitometer was provided in the silo for side edges to constantly monitor the concentration of the solvent in the silo for side edges. There is a case where explosion occurs when the concentration of the solvent in the silo for side edges exceeds 25 vol % as the lower limit of explosion (LEL), however in this embodiment, the concentration of the solvent was constantly less than 25 vol %, and there was no possibility of explosion. The chips were used again as a material for preparing the dope together with the flaky TAC. Note that air was substituted with nitrogen gas in order to keep the oxygen concentration at 5 vol %. The film 96 was preliminarily dried in a preliminary drying chamber (not shown) to which dry air at the temperature of 100° C. was supplied before being dried at high temperature in the drying chamber 74 described later.

Next, the film 96 with its side edges cut away was dried at high temperature in the drying chamber 74. The inside of the drying chamber 74 was divided into four sections, and dry air was supplied to each of the sections by the air blower (not shown). The temperature of air supplied by the air blower was 120° C., 130° C., 130° C., and 130° C. in this order from the upstream side. While the film 96 was transported at the transporting tension of 100N/width with the support of the rollers 98, the film 96 was dried for approximately 10 minutes until the residual amount of the solvent definitely became 0.3 mass %. The lap angle of the film 96 to the rollers 98 was 90 degrees and 180 degrees. The material of the rollers 98 was aluminum or carbon steel. The surface of each of the rollers 98 was subjected to hard chrome-plating, and the one surface thereof was flat, and the other thereof was matted by blast. The fluctuation of the respective rollers 98 due to the rotation was 50 μm or less. Note that deflection of the roller at the transporting tension of 100N/width was adjusted to 0.5 mm or less.

In the drying chamber 74, the solvent vapor in the drying chamber 74 was recovered by the adsorption and recovery device 99 to be removed. The adsorption and recovery were performed by using activated carbon as absorbing agent and dry nitrogen for desorption. The recovered solvent was adjusted such that the water content thereof became 0.3 mass % or less to be reused as the solvent for preparing the dope. The air in the drying chamber 74 included substances of high boiling point such as plasticizer, UV-absorbing agent, and the like in addition to the solvent vapor. The substances were cooled by a cooling device and removed by preabsorber to be circulated and reused. The absorbing and desorbing conditions were set such that VOC (volatile organic compound) contained in gas exhausted outside became 10ppm or less at the final stage. The amount of the solvent to be recovered by the condensation method relative to all the solvent vapor was 90 mass %, and most remaining solvent was recovered by absorption and desorption method.

Further, a first humidity control chamber (not shown) and second humidity control chamber (not shown) were disposed between the drying chamber 74 and the cooling chamber 75. The first and second humidity control chambers controlled the humidity of the film 96 to correct curing or the like. In the first humidity control chamber, air at a temperature of 50° C. and at a dew point of 20° C. was supplied to the film 96. Then, the film 96 was transported to the second humidity control chamber, and air at a temperature of 90° C. and at a degree of humidity of 70% was directly supplied to the film 96.

The film after the humidity control was fed into the cooling chamber 75 to be cooled until the temperature thereof became 30° C. or less. Further, the compulsory neutralization device (neutralization bar) 100 regulated the voltage applied to the film 96 such that the voltage remained constantly in the range of −3 kV to 3 kV. Thereafter, the knurling was formed on the both side ends of the film 96 by the knurling roller 101. Note that the knurling was formed by performing emboss processing starting from one end of the film 96 to the other end thereof. In this case, the width subjected to the knurling was 10 mm, and pressure applied by the knurling roller 101 was regulated such that a height of the evenness was higher than the average height of the film 96 by 12 μm on average.

The winding roller 103 (having a diameter of 169 mm) disposed in the winding chamber 76 wound up the film 96 while adjusting the tensile force at the time of starting winding to 300N/m and the tensile force at the time of finishing winding to 200N/m, thus obtaining a roll of product of the film 96 which had a width of 1340 mm and an inner width of 1313 mm with knurling formed thereon. At the time of starting winding, the temperature of the film 96 was 23° C., proportion of water contained therein was 1.0 mass %, and the residual amount of the solvent was 1 wt %. Further, inside the winding chamber 76, while the room temperature was kept at 28° C. and the humidity was kept at 70%, there was disposed a neutralization device utilizing ionic wind (not shown) to regulate the voltage applied to the film 96 to not less than −1.5 kV and not more than 1.5kv. Further, at the time of winding, a fluctuation band of winding dislocation (width of oscillation) was set to ±5 mm, winding dislocation cycle relative to the winding roller 103 was set to 400 m, and pressure applied from the press roller 105 to the winding roller 103 was set to 50 N/m. In the film production line 70, through the entire processes, average drying speed of the casting film 84, wet film 92, and the film 96 was set to 20 mass %/m. Note that the film forming speed was set to 50 m/m by a winding device.

Measurement And Evaluation of Optical Properties of Film

In Experiments 1 to 4, and Experiments 5 and 6 as Comparatives, tenter draw ratio TD and casting method (co-casting or single-layer casting) are decided as follows. Front retardation (Re) and retardation in the thickness direction (Rth) of the produced film were measured, and whether shark skin occurs or not and peelability from the cooling drum 82 were evaluated.

### Experiment 1

The tenter draw ratio was set to 114%, and the dope 27 was cast so as to form three layers (co-casting).

### Experiment 2

The tenter draw ratio was set to 120%, and the dope 27 was cast so as to form three layers (co-casting). The other conditions were the same as those in Example 1.

### Experiment 3

The tenter draw ratio was set to 125%, and the dope 27 was cast so as to form three layers (co-casting). The other conditions were the same as those in Example 1.

### Experiment 4

The tenter draw ratio was set to 150%, and the dope 27 was cast so as to form three layers (co-casting). The other conditions were the same as those in Example 1.

### Experiment 5

The tenter draw ratio was set to 160%, and the dope 27 was cast so as to form three layers (co-casting). The other conditions were the same as those in Example 1.

### Experiment 6

The tenter draw ratio was set to 104%, and the dope 27 was cast as it was (single-layer casting). The other conditions were the same as those in Example 1.

Table 1 shows the result of measurement and evaluation of the optical properties of the film 96 in each experiment.

TABLE 1

| | Re | Rth | | |
|---|---|---|---|---|
| | (nm) | (nm) | Shark skin | peelability |
| Experiment 1 | 3.6 | 42.0 | A | P |
| Experiment 2 | 2.8 | 42.0 | A | P |
| Experiment 3 | 4.3 | 41.2 | A | P |
| Experiment 4 | 7.0 | 45.0 | A | P |
| Experiment 5 | breakage | breakage | breakage | F |
| Experiment 6 | 6.1 | 43.0 | B | P |

Retardation

Retardation was calculated according to the following formulae.
Re=(nx−ny)×d
Rth={(nx+ny)/2−nz}×d
Here, “nx” represents refractive index in the direction of slow phase axis (transporting direction) in the surface of the film 96, “ny” represents refractive index in the direction of fast phase axis (width direction) in the surface of the film 96, and “nz” represents refractive index in the thickness direction of the film 96. “d” represents a thickness of the film 96. Note that, in the cellulose ester film suitable for optical use, it is preferable that Re is in the range of 0 nm to 10 nm, and Rth is in the range of 20 nm to 50 nm when the thickness width d of the film 96 is in the range of 50 μm to 110 μm.

Shark Skin

A: No shark skin occurred.

B: Shark skin occurred.

Peelability

P: No breakage occurred on the film.

F: Breakage occurred on the film.

The present invention is not to be limited to the above embodiments, and on the contrary, various modifications will be possible without departing from the scope and spirit of the present invention as specified in claims appended hereto.

What is claimed is:

1. A production method of a polymer film comprising the steps of:
casting a plurality of dopes containing a polymer and a solvent so as to be stacked onto a rotating support to obtain a casting film composed of a plurality of layers;
cooling and solidifying said casting film;
peeling said solidified casting film from said support to obtain a wet film;
drying said wet film while transportation thereof in a tenter, said tenter including holding members for holding both side ends of said wet film running along a transporting path to transport said wet film; and
setting a tenter draw ratio obtained by a formula 100×x/y to not less than 110% and not more than 150%, said x being a running speed of said holding member and said y being a rotating speed of said support.

2. A production method of a polymer film as defined in claim 1, wherein among said plurality of layers viscosity of said dope for an exposure layer and viscosity of said dope for a contacting layer in contact with said support are lower than viscosity of said dope for an intermediate layer between said exposure layer and said contacting layer.

3. A production method of a polymer film as defined in claim 2, wherein the viscosity of said dope for said intermediate layer is not less than 6.00×10 Pa·s and not more than 10.00×10 Pa·s, and the viscosity of said dope for said exposure layer and for said contacting layer is not less than 3.00×10 Pa·s and not more than 8.00×10 Pa·s.

4. A production method of a polymer film as defined in claim 1, wherein said wet film is transported by a plurality of rollers provided between said support and said tenter, a rotating speed of (n+1)th roller from an upstream side is faster than a rotating speed of nth roller among said rollers (n=natural number).
